(19) United States
(12) Patent Application Publication
(10) Pub. No.: US 2012/0301193 A1
(43) Pub. Date: Nov. 29, 2012

(54) FIXING DEVICE, FIXING METHOD, IMAGE FORMING APPARATUS, AND IMAGE FORMING METHOD

(76) Inventors: Takanori Inadome, Kanagawa (JP); Takuma Nakamura, Kanagawa (JP); Yuichi Aoyama, Kanagawa (JP); Shunichi Abe, Kanagawa (JP); Tetsurou Sasamoto, Kanagawa (JP); Masafumi Yamada, Kanagawa (JP); Kazuya Nagao, Kanagawa (JP)

(21) Appl. No.: 13/576,970

(22) PCT Filed: Mar. 7, 2011
(86) PCT No.: PCT/JP11/55865

§ 371 Date: Aug. 3, 2012

(30) Foreign Application Priority Data
Mar. 11, 2010 (JP) 2010-054060
Oct. 21, 2010 (JP) 2010-236175

(51) Int. Cl. G03G 15/20

(52) U.S. Cl. 399/320

(57) ABSTRACT

A fixing device for applying a foam fixing agent to particles including resin resting on a medium to fix the particles including resin onto the medium. The foam fixing agent includes a softener for softening the particles including resin by dissolving or swelling at least part of the resin. The fixing device includes a first foam fixing agent generating unit that generates a first foam fixing agent from a fixing agent; a second foam fixing agent generating unit that generates a second foam fixing agent from the fixing agent, the second foam fixing agent having a lower density than the first foam fixing agent; and a foam application member on which a first film formed with the first foam fixing agent and a second film formed with the second foam fixing agent are formed.

### TECHNICAL FIELD

The present invention relates to a fixing device and a fixing method using a foam fixing agent, an image forming apparatus including the fixing device, and an image forming method using the fixing method.

### BACKGROUND ART

An image forming apparatus, such as a printer, a facsimile machine, a copier, or a multifunction peripheral including these functions, forms various images including characters, symbols, graphics, or photographs, on a recording medium, such as paper, cloth, or an OHP (overhead projector) sheet, based on image information. Particularly, an electrophotographic image forming apparatus capable of forming a high-resolution image on a plain paper sheet at high speed is particularly widely used in offices.

Such an electrophotographic image forming apparatus typically uses a heat fixing process in which toner resting on a recording medium is fixed onto the recording medium by heating and melting the toner and applying pressure to the melted toner. The heat fixing process is used to provide high-speed fixing and high-quality fixed images.

However, the operation of heating the toner in the heat fixing process consumes approximately half or more of the total power consumed by the electrophotographic image forming apparatus.

In view of current environmental issues, a fixing device with low power consumption (an energy-saving fixing device) is desirable.

Specifically, it is desirable to significantly lower the heating temperature for fixing the toner, or to eliminate the need for toner heating altogether.

A non-heat fixing method in which toner is fixed onto a recording medium without heating the toner at all is ideal in terms of low power consumption.

One example of the non-heat fixing method is a method that uses an oil-in-water fixing agent in which an organic compound, which dissolves or swells toner and which is insoluble or hardly soluble in water, is dispersed in and mixed with water. The method involves turning oil-in-water fixing agent into foam, forming a film of foam on a roller, applying the foam so as to permeate the unfixed toner located at a predetermined position on the surface of an object (recording medium) to dissolve or swell the toner, and then drying the object.

For example, patent document 1 discloses a fixing method for causing a fixing agent to permeate the unfixed toner on an object (recording medium) without disrupting the unfixed toner. This method involves turning the fixing agent into foam, applying the foam so as to permeate the unfixed toner to dissolve or swell the toner, and then drying the object.

Patent document 2 discloses a foam fixing agent generating device including a control unit for achieving a foam fixing agent having a desired level of density.

Patent document 3 discloses an application device for forming a multilayer application film on a moving supporting medium such as plastic, paper, or metal foil. Specifically, the application device uses an extrusion type coater head for discharging and applying a coating liquid to a support medium. The application device includes a first slit connected to a first manifold for supplying the coating liquid of the lower layer. The application device includes a second slit connected to a second manifold for supplying the coating liquid of the upper layer. The second slit merges with the first slit at the middle of the first slit.

However, in the conventional systems described above, when the foam fixing agent is applied to unfixed toner on a recording medium with a roller so as to permeate the unfixed toner, some of the foam fixing agent may remain on the roller without permeating the unfixed toner.
Patent Document 1: Japanese Patent No. 4324242
Patent Document 2: Japanese Laid-Open Patent Publication No. 2009-103778
Patent Document 3: Japanese Laid-Open Patent Publication No. 2004-025002

### DISCLOSURE OF INVENTION

The present invention has been made in view of the above-described problems, and it is an object of at least one embodiment of the present invention to provide a fixing device, a fixing method, an image forming apparatus including the fixing device, and an image forming method using the fixing method, which are capable of reducing the amount of a foam fixing agent remaining on a foam application member such as a roller after the fixing process.

An aspect of the present invention provides a fixing device for applying a foam fixing agent to particles including resin resting on a medium to fix the particles including resin onto the medium, the foam fixing agent including a softener for softening the particles including resin by dissolving or swelling at least part of the resin, the foam fixing agent including a first foam fixing agent and a second foam fixing agent, the fixing device including a first foam fixing agent generating unit that generates the first foam fixing agent from a fixing agent; a second foam fixing agent generating unit that generates the second foam fixing agent from the fixing agent, the second foam fixing agent having a lower density than the first foam fixing agent; and a foam application member on which a first film formed with the first foam fixing agent and a second film formed with the second foam fixing agent are formed.

An aspect of the present invention provides a fixing method for applying a foam fixing agent to particles including resin resting on a medium to fix the particles including resin onto the medium, the foam fixing agent including a softener for softening the particles including resin by dissolving or swelling at least part of the resin, the foam fixing agent including a first foam fixing agent and a second foam fixing agent, the fixing method including generating the first foam fixing agent from a fixing agent; generating the second foam fixing agent from the fixing agent, the second foam fixing agent having a lower density than the first foam fixing agent; and applying the first foam fixing agent and the second foam fixing agent to the particles including resin resting on the medium, with the use of a foam application member on which a first film formed with the first foam fixing agent and a second film formed with the second foam fixing agent are formed.

### BRIEF DESCRIPTION OF DRAWINGS

FIG. 1 is an overall schematic diagram of an image forming apparatus according to an embodiment of the present invention;

FIG. 2 is an enlarged view of relevant parts in an image forming section shown in FIG. 1;

FIGS. 3A and 3B are for describing the fixing principle of a foam fixing agent;

FIG. 4 is for describing a foam fixing agent generating unit;

FIGS. 5A and 5B are for describing the image forming section provided with a fixing device including a foam fixing agent generating unit shown in FIG. 4;

FIG. 6 is for describing the image forming section according to an embodiment of the present invention, including a fixing device having two foam fixing agent generating units;

FIG. 7 illustrates a two-layer foam fixing agent film on a foam application roller according to an embodiment of the present invention;

FIG. 8 illustrates another example of a two-layer foam fixing agent film on a foam application roller according to an embodiment of the present invention;

FIG. 9 illustrates yet another example of a two-layer foam fixing agent film on a foam application roller according to an embodiment of the present invention;

FIG. 10 illustrates an example of a process of transferring a foam fixing agent in the fixing system using a two-layer foam fixing agent film;

FIG. 11 illustrates another example of a foam fixing agent; and

FIG. 12 illustrates an example of a foam fixing agent having a higher density than that of the foam fixing agent shown in FIG. 11.

### BEST MODE FOR CARRYING OUT THE INVENTION

Embodiments of the present invention are described below with reference to the accompanying drawings.

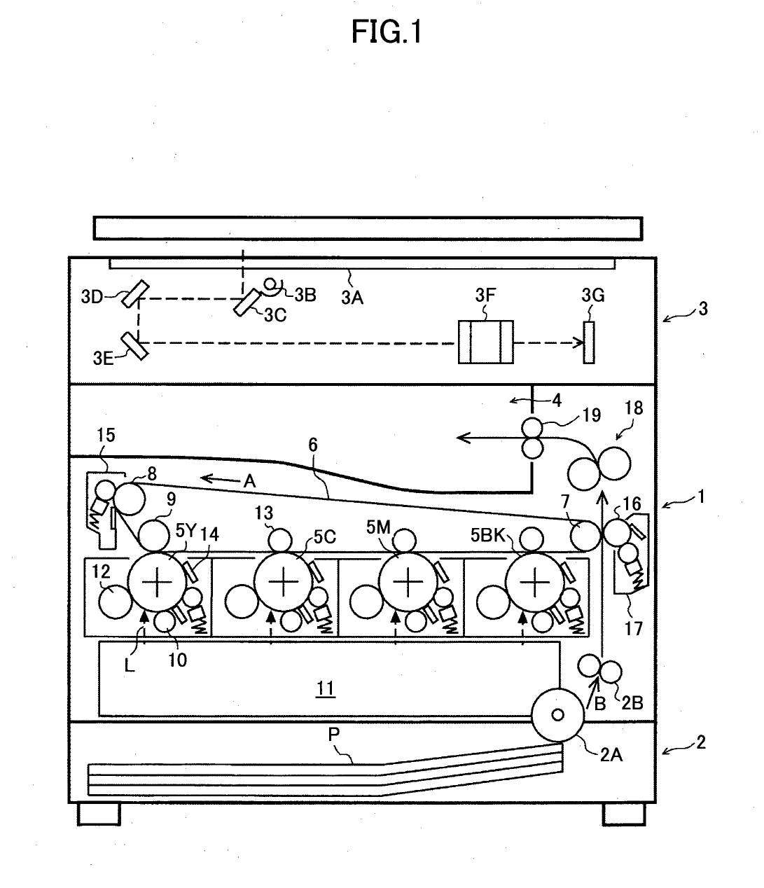

FIG. 1 is an overall schematic diagram of an image forming apparatus according to an embodiment of the present invention.

The image forming apparatus shown in FIG. 1 is a color image forming apparatus including an image forming section 1 located at substantially the center of the image forming apparatus; a sheet feeding section 2 located below the image forming section 1; an image scanning section 3 located above the image forming section 1; and an internal sheet eject section 4 located between the image forming section 1 and the image scanning section 3. The image forming apparatus has functions of a printer, a copier, a fax machine, and a scanner. Although not shown in FIG. 1, an automatic document feeder (ADF) is provided above the image scanning section 3.

As shown in FIG. 1, the image scanning section 3 includes an exposure glass 3A, an original illumination light source 3B and a first mirror 3C that are mounted on a scanning carrier, a second mirror 3D, a third mirror 3E, a focus lens 3F, and an imaging element 3G. An original document mounted on the exposure glass 3A by the ADF or by manual feed is scanned with the imaging element 3G. An image processing unit (not shown) converts the image into image information (including image signals corresponding to the respective colors of, for example, yellow (Y), cyan (C), magenta (M), and black (BK)) that can be used for writing an image. Then, the image information is sent to the image forming section 1.

The image forming section 1 includes plural image carriers 5Y, 5C, 5M, and 5BK configured with drum-type photoconductors. Toner images of different colors are formed on the respective image carriers 5Y, 5C, 5M, and 5BK. In the example in FIG. 1, color toner images of a yellow toner image, a cyan toner image, and a magenta toner image are formed on the surfaces of the image carriers 5Y, 5C, and 5M, respectively, and a black toner image is formed on the image carrier 5BK. The image carriers 5Y, 5C, 5M, and 5BK are arranged parallel to each other, with predetermined intervals therebetween. An intermediate transfer body 6 is arranged so as to face the image carriers 5Y, 5C, 5M, and 5BK. The intermediate transfer body 6 may be configured with a drum; in the example shown in FIG. 1, the intermediate transfer body 6 is an endless belt that is wound around plural supporting rollers 7, 8, and 9 and that is rotated in a direction indicated by an arrow A.

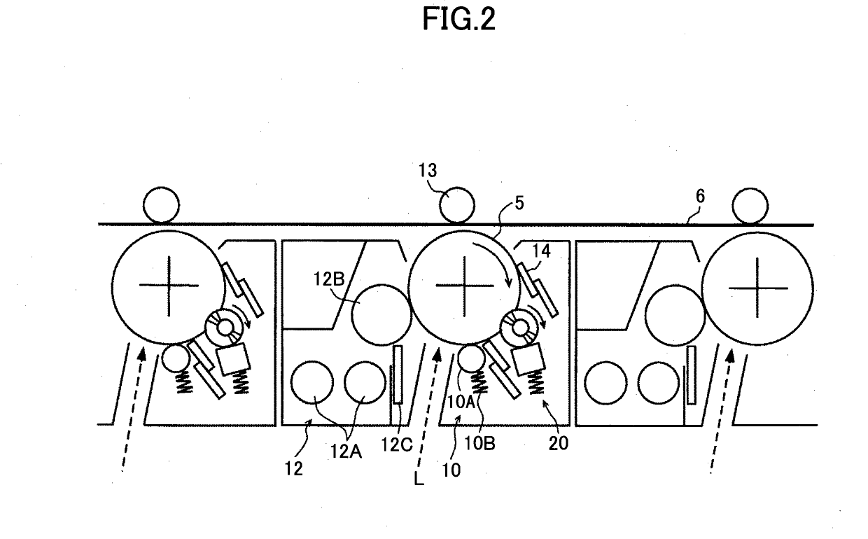

FIG. 2 is an enlarged view of relevant parts (image forming unit of each color) in the image forming section 1 shown in FIG. 1. The four image forming units for yellow (Y), cyan (C), magenta (M), and black (BK) shown in FIG. 1 have the same configurations. Therefore, FIG. 2 only shows one of the image forming units and symbols indicating the color are not shown.

As shown in FIG. 2, various elements are provided around the image carrier 5. The elements include a charging device 10 for charging the surface of the image carrier 5; an exposing device 11 (see FIG. 1) for applying image information onto the surface of the photoconductor by radiating a laser beam L; a developing device 12 for developing an electrostatic latent image, which has been formed on the surface of the image carrier 5 by an exposing process, into a visible image; a transfer device 13 facing the image carrier 5 via the intermediate transfer body 6; a cleaning device 14 for removing and collecting toner remaining on the surface of the image carrier 5 after the toner image has been transferred to the intermediate transfer body 6; and a lubricant applying device 20 for decreasing the friction coefficient on the surface of the image carrier 5.

The charging device 10 includes a charging roller 10A as a charging member, and a spring 10B as a biasing member for pressing the charging roller 10A against the image carrier 5 by applying predetermined pressure. Although not shown, the charging roller 10A includes a conductive elastic layer provided around a conductive shaft. A voltage applying device (not shown) applies electrical charges to the surface of the image carrier 5 by applying a predetermined voltage to a space between the conductive elastic layer and the image carrier 5 via the conductive shaft. Furthermore, the developing device 12 sufficiently stirs the developer with stirring screws 12A, and causes the developer to magnetically adhere to a developing roller 12B. The developer adhering on the developing roller 12B is turned into a thin layer by a developing doctor blade 12C. The electrostatic latent image on the image carrier 5 is turned into a visible image by the developer. The transfer device 13 includes a transfer bias roller with which the toner image on the image carrier 5 is transferred to the intermediate transfer body 6 so as to electrically adhere to the intermediate transfer body 6. The cleaning device 14 includes a cleaning sheet made of urethane rubber, and the cleaning sheet scrapes off the toner remaining on the image carrier 5.

In the present embodiment, each of the image forming units of the respective colors is a process cartridge (PC) formed by combining, in a unit, the image carrier 5, the charging device 10, the developing device 12, the cleaning device 14, and the lubricant applying device 20. The process cartridge (PC) may have any format. In an embodiment of the present invention, the process cartridge (PC) is formed by combining the lubricant applying device 20 with at least one of the image carrier 5, the charging device 10, the developing device 12, and the cleaning device 14.

When the above-described image forming apparatus starts an image forming process, in each of the image forming units of the respective colors, the image carrier 5 rotates in a clockwise direction as viewed in FIG. 2. The charging device 10 charges the surface of the image carrier 5 to a predetermined polarity. Next, on the charged surface, the exposing device 11 shown in FIG. 1 radiates a laser beam L based on image information. Accordingly, an electrostatic latent image is formed on the image carrier 5. The image information may be image data obtained by a scanning process of the image scanning section 3, data sent from an external computer via a LAN, or data received by fax transmission. When the image scanning section 3 is used to obtain the image information, the scanning carrier including the original illumination light source 3B and the first mirror 3C moves back and forth to scan an original document (not shown) placed on the exposure glass 3A. The image information obtained by the scanning process of the scanning carrier, is read as image signals by the imaging element 3G (e.g., a CCD) provided behind the focus lens 3F, via the second mirror 3D, the third mirror 3E, and the focus lens 3F. The image signals that have been read are subjected to digital conversion and image processing, and are written onto the surface of the image carrier 5 as a laser diode (not shown) of the exposing device 11 emits light. Then, the electrostatic latent image formed on the surface of the image carrier 5 is turned into a visible toner image by the dry developer (developer including resin particles (toner) containing resin and color materials) carried on the developing roller 12B of the developing device 12.

The image forming operation described above is performed on all of the image carriers 5Y, 5C, 5M, and 5BK shown in FIG. 1. A yellow toner image, a cyan toner image, a magenta toner image, and a black toner image formed on the respective image carriers 5Y, 5C, 5M, and 5BK by the image forming operation are sequentially superposed on the intermediate transfer body 6. Furthermore, in the image forming apparatus shown in FIG. 1, a secondary transfer device (for example, a secondary transfer roller) 16 is provided facing the supporting roller 7 via the intermediate transfer body 6.

Meanwhile, a recording medium P, which may be a transfer sheet (plain paper sheet of a standard size, a continuous form, a letter sheet, a post card, a cardboard sheet, etc.) or a resin film (an OHP sheet, etc.), is sent out from the sheet feeding section 2 located below the image forming section 1, by a sheet feeding roller 2A in a direction indicated by an arrow B. The recording medium P is sent in between the secondary transfer device 16 and the intermediate transfer body 6, at a predetermined timing by the rotation of a pair of resist rollers 2B. As described above, when the recording medium P passes through the secondary transfer device 16, the toner images superposed on the intermediate transfer body 6 are transferred onto the recording medium P at once by the function of the secondary transfer device 16. Then, a fixing device 18 fixes the toner images on the recording medium P. Subsequently, the recording medium P is ejected to the internal sheet eject section 4 by a sheet eject roller 19. Residual toner adhering to the intermediate transfer body 6 after the toner has been transferred from the intermediate transfer body 6 to the recording medium P, is removed by a cleaning device 15 for belts. Then, the toner and paper particles adhering to the surface of the roller in the secondary transfer device 16, are removed by a cleaning device 17 for rollers. The cleaning device 15 for belts and the cleaning device 17 for rollers may be provided with lubricant applying devices according need.

Next, a detailed description is given of the fixing device and fixing method according to an embodiment of the present invention.

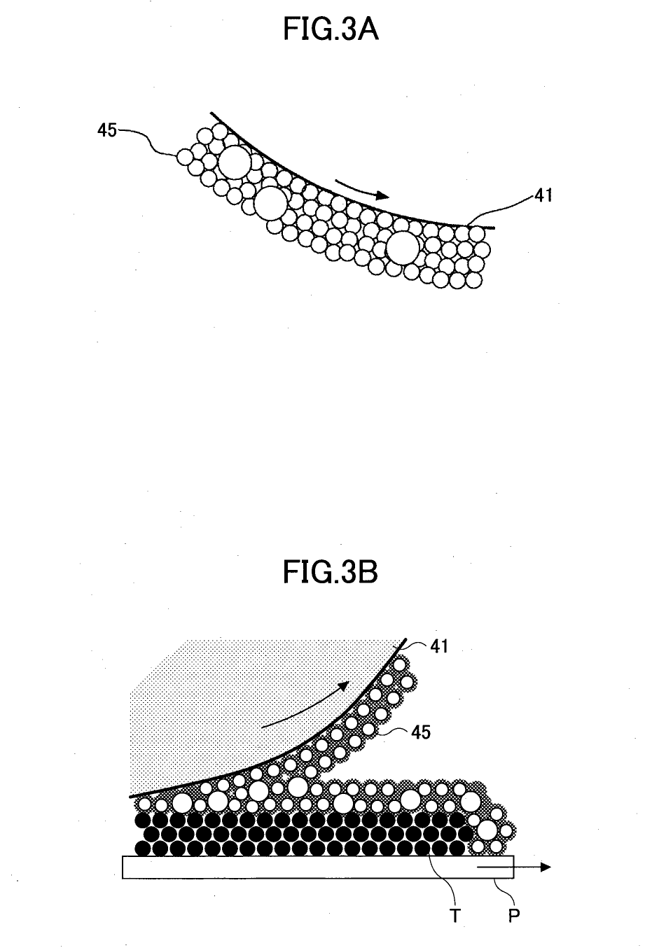

FIGS. 3A and 3B are for describing the fixing principle of the foam fixing agent. As shown in FIGS. 3A and 3B, the fixing device and fixing method according to an embodiment of the present invention use a foam fixing agent 45 including a softener that softens particles including resin by dissolving or swelling at least a part of the resin. The foam fixing agent 45 is applied to resin particles (unfixed toner T) on the recording medium P to fix the resin particles onto the recording medium P.

Specifically, a foam fixing agent generating unit (described below) turns a fixing agent into foam to generate the foam fixing agent 45. Accordingly, the bulk density of the fixing agent can be reduced. Furthermore, as shown in FIG. 3A, the thickness of the fixing agent layer (foam fixing agent film) 45 on a foam application roller 41 (foam application member) can be increased (the foam application roller 41 is included in the fixing device 18). Furthermore, the impact of surface tension of the fixing agent can be reduced, and therefore the offset of resin particles onto the foam application roller 41 can be prevented.

The fixing agent described in patent documents 1 and 2 applied by the applicant of the present invention may be used as the fixing agent including a softener, which is used for generating the foam fixing agent.

As the foam application roller 41 contacts the recording medium P while the recording medium P is being conveyed, the foam fixing agent 45 is transferred to the unfixed toner T on the recording medium P to permeate the unfixed toner T.

It is known that not all of the foam fixing agent 45 is transferred to the recording medium P. As shown in FIG. 3B, it is known that some of the foam fixing agent 45 remains on the foam application roller 41. As a result of various experiments, it is known that the volume ratio of the fixing agent on recording medium:the volume ratio of the fixing agent remaining on foam application roller is 7:3.

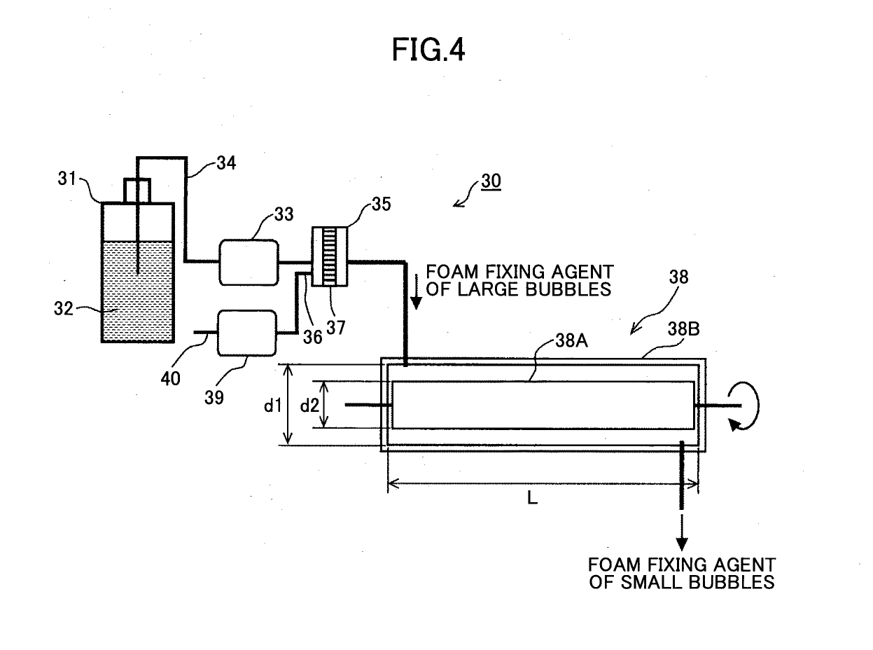

FIG. 4 is for describing the foam fixing agent generating unit.

A foam fixing agent generating unit 30 shown in FIG. 4 generates a foam fixing agent having large bubbles from a liquid fixing agent. Then, the foam fixing agent generating unit 30 separates the bubbles and generates a foam fixing agent having small bubbles. As shown in FIG. 4, a large bubble generating unit included in the foam fixing agent generating unit 30 involves supplying a liquid fixing agent 32 contained in a fixing agent container 31 to a gas/liquid mixing unit 35, with the use of a liquid transporting unit such as a liquid conveying pump 33 and a liquid conveying pipe 34. Furthermore, air is supplied from an air opening 40 to the gas/liquid mixing unit 35 with the use of a gas transporting unit such as a gas conveying pump 39 and a gas conveying pipe 36. Compressed air may be used as the air.

In the gas/liquid mixing unit 35, the liquid and air that have been conveyed as described above are mixed together and then passed through a microporous sheet 37, so that bubbles having similar sizes are created. The size of pores in the microporous sheet 37 is preferably approximately 30 μm through 100 μm. Furthermore, the microporous sheet 37 is not limited to that shown in FIG. 4. The microporous sheet 37 may be any porous member having a continuous foam structure, such as a sintered ceramic plate, a nonwoven cloth, and a foam resin sheet having pores of approximately 30 μm through 100 μm. Another method of generating large bubbles is to use a fin type stirrer to stir together a liquid fixing agent supplied from the liquid conveying pump 33 with air supplied from the gas conveying pump 39, so that bubbles are mixed into the liquid. Yet another method of generating large bubbles is to perform bubbling with the use of an air supplying pump on a liquid fixing agent supplied from the liquid conveying pump 33.

The foam fixing agent generating unit 30 shown in FIG. 4 includes a small bubble generating unit 38 for applying a shear force on the large bubbles generated by the gas/liquid mixing unit 35 to divide each large bubble into two or more bubbles. As shown in FIG. 4, the small bubble generating unit 38 includes two closed circular cylinders, i.e., an outer cylinder 38B and a rotatable inner cylinder 38A provided inside the outer cylinder 38B. The inner cylinder 38A is rotatable. The large-bubble foam fixing agent generated by the gas/liquid mixing unit 35 is provided to the small bubble generating unit 38 through a part of the outer cylinder 38B, and is passed through a gap (flow path) between the inner cylinder 38A rotating inside and the outer cylinder 38B. Accordingly, the large-bubble foam fixing agent receives a shear force from the rotating inner cylinder 38A. Due to this shear force, the large bubbles turn into small bubbles, so that a foam fixing agent having small bubbles having a desired size is discharged through a foam outlet provided in the outer cylinder 38B.

Furthermore, the liquid conveying speed is determined by the rotating speed of the inner cylinder 38A and the length of the inner cylinder 38A in the longitudinal direction. Assuming that the outer cylinder 38B has an inner diameter of d1 (mm) and a length of L (mm), and the inner cylinder 38A has an outer diameter of d2 (mm) and a rotating speed of R (rpm), the liquid conveying speed V (mm³/sec.) for generating small bubbles is obtained by the following formula.

V=L×n×(d1²−d2²)/4/(1000/R)

For example, assuming that d1 is 10 mm, d2 is 8 mm, L is 50 mm, the rotating speed R is 1000 rpm, the liquid conveying speed is approximately 1,400 mm³/sec. (1.4 cc/sec.). Assuming that 3 cc is the required amount of foam fixing agent for fixing the toner onto an A4-sized transfer sheet as the recording medium P, the time required to generate the desired amount of foam fixing agent from a liquid fixing agent is approximately two seconds. Accordingly, a foam fixing agent having desired bubble sizes can be generated very quickly. Furthermore, spiral grooves may be provided on the inner cylinder 38A for the purpose of improving liquid conveying properties in the cylindrical small bubble generating unit 38.

As described above, in the foam fixing agent generating unit 30 shown in FIG. 4, a large bubble generating unit (gas/liquid mixing unit 35) for changing the liquid fixing agent 32 into an agent with large bubbles, and the liquid conveying pump 33 for generating small bubbles by applying a shear force on the large bubbles, are used in combination. Accordingly, the foam fixing agent generating unit 30 can generate, from the liquid fixing agent 32, a foam fixing agent having small bubble sizes of approximately 5 μm through 50 μm, within a significantly short period of time.

The bulk density of the foam fixing agent is preferably within a range of approximately 0.01 g/cm³ through 0.1 g/cm³. The bulk density may be controlled by changing the flow volume ratio of liquid and gas per unit time, by changing the output from the liquid conveying pump 33 and the gas conveying pump 39.

Furthermore, as long as the fixing agent is in a foam-like form when it is applied onto a layer of resin particles such as toner resting on a recording medium on a sheet of paper, etc., the fixing agent does not need to be in a foam-like form when it is stored in a storage container or in the fixing agent container 31 of the foam fixing agent generating unit 30. That is to say, the fixing agent is preferably a foam-free liquid when it is stored in a storage container or in the fixing agent container 31. The fixing agent is preferably turned into foam when it is discharged from the container, or while it is passing through a liquid conveying path before being applied to a resin particle layer. Such a configuration is advantageous in that the container can be made compact, if the fixing agent is a liquid in the fixing agent container 31 and turned into foam after it is discharged from the fixing agent container 31.

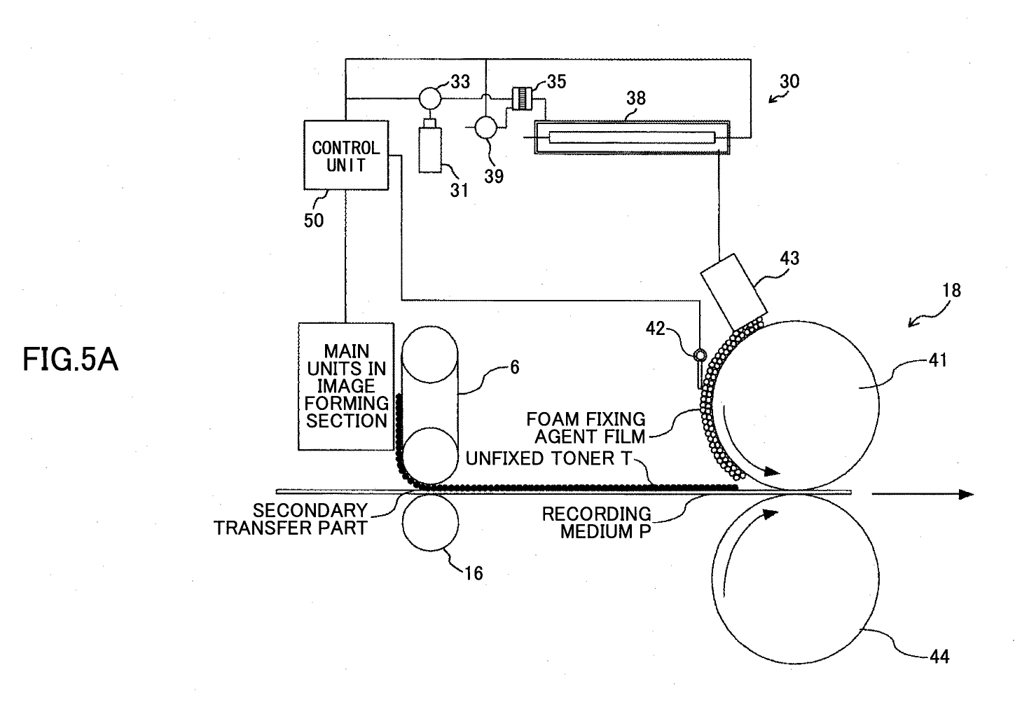

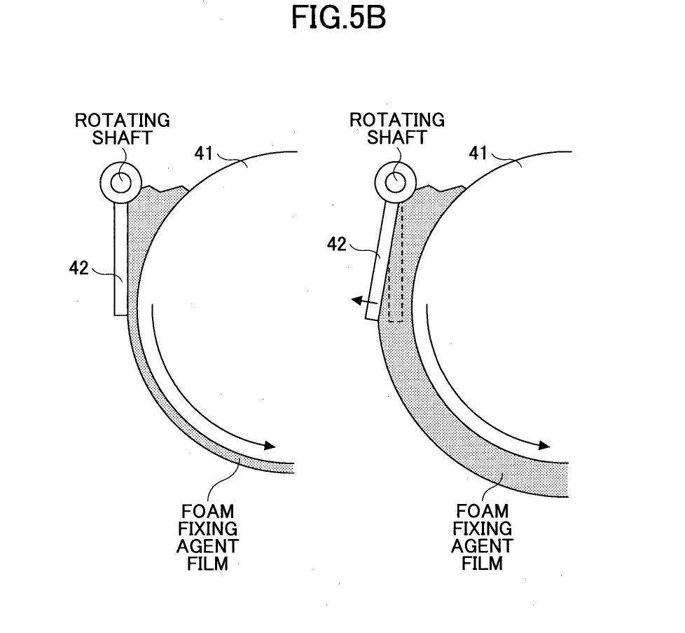

FIGS. 5A and 5B are for describing the image forming section 1 provided with the fixing device 18 including the foam fixing agent generating unit 30 shown in FIG. 4.

A control unit 50 shown in FIG. 5A is for controlling the main units in the image forming section 1 shown in FIG. 2 (the image forming units for the respective colors, the intermediate transfer body 6, the secondary transfer device 16, etc.), and the fixing device 18 including the foam fixing agent generating unit 30 shown in FIG. 4.

As described above, in the image forming units of the respective colors in the image forming section 1 as shown in FIG. 2, images of the respective colors are formed on the image carriers 5, and the images are then transferred to the intermediate transfer body 6. The unfixed toner image formed on the intermediate transfer body 6 is transferred from the secondary transfer device 16 to the recording medium P at a secondary transfer part. The control unit 50 controls main units of the image forming section 1. Specifically, the control unit 50 controls the supplying amount and bulk density of the foam fixing agent generated at the foam fixing agent generating unit 30 to be appropriate values in accordance with the unfixed toner image formed on the recording medium P. Furthermore, the control unit 50 also controls a film thickness controlling blade 42, so that the film thickness of the foam fixing agent on the foam application roller 41 of the fixing device 18 is an optimum thickness in accordance with the supplying amount.

For example, when the amount of toner in the unfixed toner image is small, the supplying amount and the film thickness are reduced.

The foam fixing agent generated by the foam fixing agent generating unit 30 as described above is sent to a foam discharge head 43 by a foam conveying pipe connected to a foam outlet provided in the outer cylinder 38B of the small bubble generating unit 38. The foam discharge head 43 discharges the foam on the foam application roller 41. The film thickness controlling blade 42 is used to adjust the film thickness of the foam, so that a foam fixing agent film having a desired thickness is formed on the foam application roller 41.

In the fixing process, this foam fixing agent is brought into contact with/applied to the unfixed toner image on the recording medium P, at a position where the foam application roller 41 and a pressure roller 44 contact each other.

As shown in FIG. 5B, the operation of controlling the film thickness of the foam fixing agent on the foam application roller 41 is performed with the use of the rotatable film thickness controlling blade 42 that is spaced away from the foam application roller 41. When the film thickness is to be reduced, the gap between the foam application roller 41 and the film thickness controlling blade 42 is reduced as shown on the left side of FIG. 5B. When the film thickness is to be increased, the gap between the foam application roller 41 and the film thickness controlling blade 42 is increased as shown on the right side of FIG. 5B.

An example of a method of controlling the gap is performed as follows. Specifically, a rotating shaft having a rotating driving unit (a stepping motor, a solenoid, etc.) is provided at the end of the film thickness controlling blade 42. This rotating shaft is controlled by the control unit 50 to adjust the gap in accordance with the thickness of the toner layer, the environmental temperature, the bubble size in the foam fixing agent, the foam viscosity, the application pressure, and the thickness of the unfixed toner layer. Accordingly, the foam fixing agent is made to have an optimum film thickness, for adjusting the time taken to permeate the unfixed toner layer with the foam fixing agent.

A basic embodiment of the image forming apparatus according to an embodiment of the present invention and the fixing device 18 including the foam fixing agent generating unit 30 provided in the image forming apparatus is described above. Furthermore, another embodiment of the present invention has the following features relevant to the process of applying the foam fixing agent on the foam application roller 41.

According to an embodiment of the present invention, there are two foam fixing agent generating units for applying the foam fixing agent onto the foam application member such as a roller. Accordingly, two types of foam fixing agents having different densities and properties are applied onto the foam application member, so that two types of foam films are formed. This embodiment is described below.

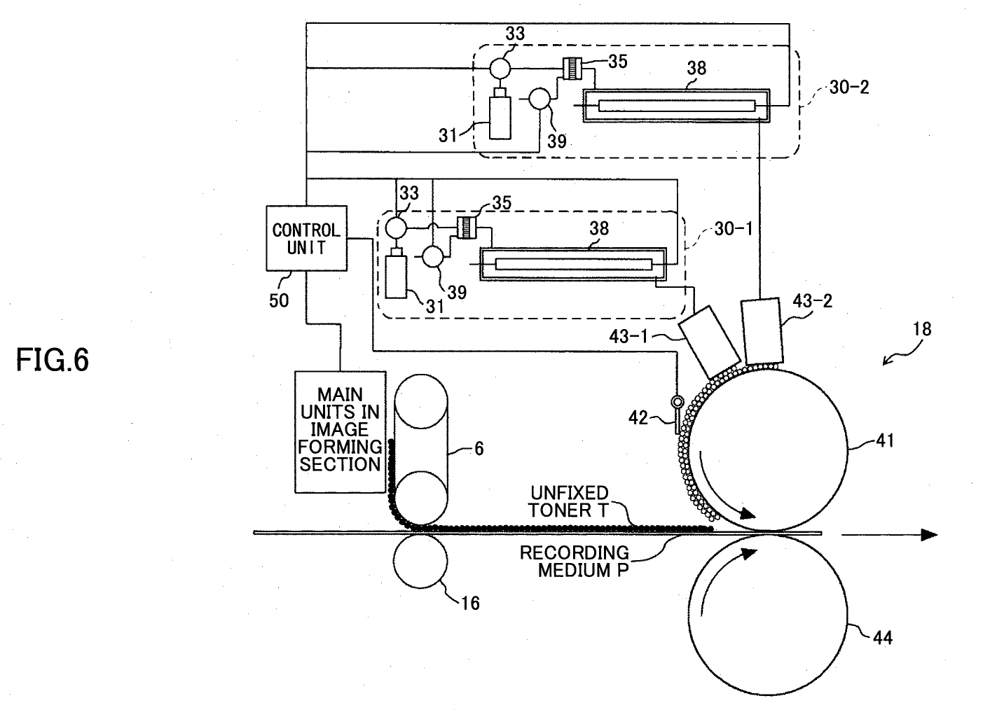

FIG. 6 is for describing the image forming section 1 according to an embodiment of the present invention, including a fixing device having two foam fixing agent generating units.

The image forming unit shown in FIG. 6 is formed by adding another foam fixing agent generating unit to the image forming section 1 shown in FIG. 5A.

Specifically, in the present embodiment, the fixing device 18 includes a first foam fixing agent generating unit 30-1 and a second foam fixing agent generating unit 30-2. The first foam fixing agent generating unit 30-1 generates a foam fixing agent from a fixing agent including a softener that softens particles including resin by dissolving or swelling at least apart of the resin. The second foam fixing agent generating unit 30-2 generates a foam fixing agent of a lower density than the foam fixing agent generated by the first foam fixing agent generating unit 30-1.

The basic structures of the first foam fixing agent generating unit 30-1 and the second foam fixing agent generating unit 30-2 are the same as the foam fixing agent generating unit 30 shown in FIG. 4. In the present embodiment, the second foam fixing agent generating unit 30-2 generates a foam fixing agent having a low density, and the generated foam fixing agent is applied to the foam application roller 41 with a foam discharge head 43-2. Then, the first foam fixing agent generating unit 30-1 generates a foam fixing agent used for fixing, and the generated foam fixing agent is applied to the foam application roller 41 with a foam discharge head 43-1. Accordingly, a two-layer foam film is formed on the foam application roller 41, including two different foam layers having different densities. In the present embodiment, after forming a two-layer foam fixing agent film on the foam application roller 41 as described above, a fixing process is performed by having the two-layer foam fixing agent film brought into contact with/applied to the unfixed toner image on the recording medium P, by the foam application roller 41.

Next, a description is given of a two-layer foam fixing agent film on a foam application roller according to an embodiment of the present invention.

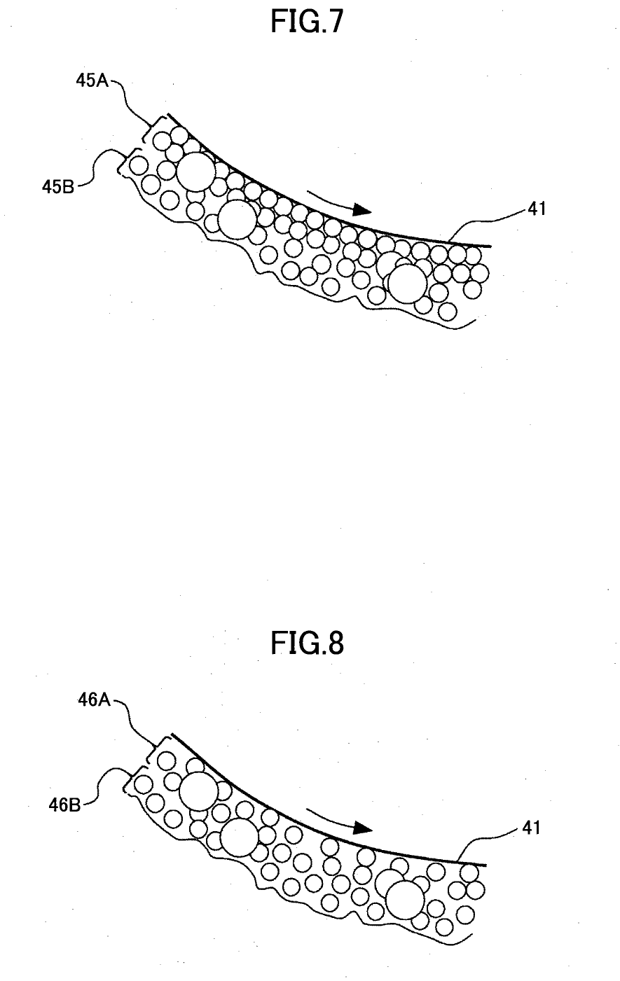

FIG. 7 illustrates a two-layer foam fixing agent film on a foam application roller according to an embodiment of the present invention.

The foam fixing agent film on the foam application roller 41 includes a layer of a foam fixing agent film 45A having low density, which is generated by the second foam fixing agent generating unit 30-2 shown in FIG. 6. On top of the foam fixing agent film 45A, there is provided a foam fixing agent film 45B used for fixing, which is generated by the first foam fixing agent generating unit 30-1 shown in FIG. 6.

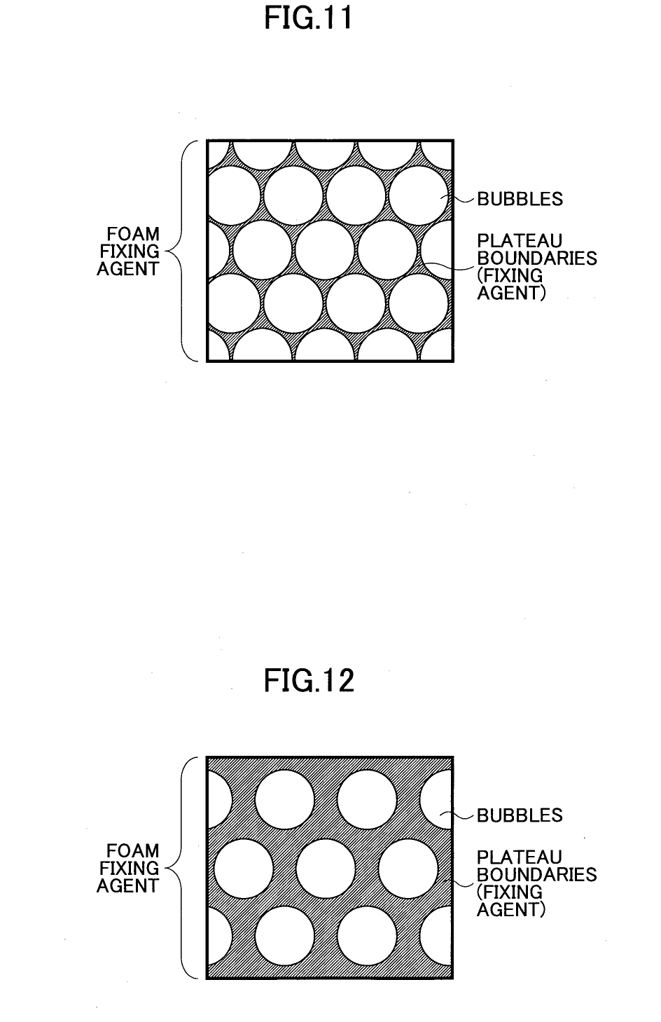

FIG. 11 illustrates an example of a foam fixing agent. As shown in FIG. 11, the foam fixing agent, which is formed by bubbles and a fixing agent, includes bubbles and liquid film boundaries for partitioning the bubbles (hereinafter, “plateau boundaries”).

Furthermore, FIG. 12 illustrates an example of a foam fixing agent having a higher density than that of the foam fixing agent shown in FIG. 11. When the foam density is high, the ratio of the plateau boundaries (fixing agent) per unit volume is high.

The foam density is the mass of the fixing agent per unit volume. When the foam density is low, it means that there is a large number of bubble particles per unit volume and the plateau boundaries are thin. Meanwhile, when the foam density is high, it means that there is a small number of bubble particles per unit volume and the plateau boundaries are thick.

In the foam fixing agent film 45B used for fixing shown in FIG. 7 (the foam fixing agent film generated by the first foam fixing agent generating unit 30-1), the ratio of the plateau boundaries (fixing agent) per unit volume is higher than that in the foam fixing agent film 45A having a low density, as described with reference to FIGS. 11 and 12.

In an embodiment of the present invention, in order to reduce the amount of foam fixing agent remaining on the foam application roller 41, the foam fixing agent film 45A generated by the second foam fixing agent generating unit 30-2 is made to have a lower density than the foam fixing agent film 45B generated by the first foam fixing agent generating unit 30-1.

Next, a description is given of another example of the two-layer foam fixing agent film on the foam application roller according to an embodiment of the present invention.

In the fixing device and fixing method according to an embodiment of the present invention, the foam remaining on the foam application roller 41 after the fixing process, is not used for fixing, and thus does not need to include a softener. Accordingly, the second foam fixing agent generating unit 30-2 for generating a foam fixing agent having low density may use a fixing agent that does not include a softener.

As the second foam fixing agent generating unit 30-2 may use an agent that does not include a softener, the cost of the fixing agent can be reduced.

FIG. 8 illustrates a fixing agent that does not include a softener being used as a foam fixing agent film 46A having a low density. The foam fixing agent film on the foam application roller 41 shown in FIG. 8 includes a layer of the foam fixing agent film 46A without a softener, which is generated by the second foam fixing agent generating unit 30-2 shown in FIG. 6. On top of the foam fixing agent film 46A, there is provided a foam fixing agent film 46B used for fixing including a softener, which is generated by the first foam fixing agent generating unit 30-1 shown in FIG. 6.

In the example of FIG. 8, both the foam fixing agent films 46A and 46B have the same foam density; however, as described with reference to FIG. 7, the second foam fixing agent generating unit 30-2 may form a foam fixing agent film that does not include a softener and that has a low density.

In the example of FIG. 8, the foam fixing agent generated by the first foam fixing agent generating unit 30-1 (the foam that contacts the toner) includes a softener, while the foam fixing agent generated by the second foam fixing agent generating unit 30-2 does not include a softener. The foam fixing agents may have different foam densities as described with reference to FIG. 7, or may have the same foam densities.

Next, a description is given of another example of a two-layer foam fixing agent film on the foam application roller according to an embodiment of the present invention.

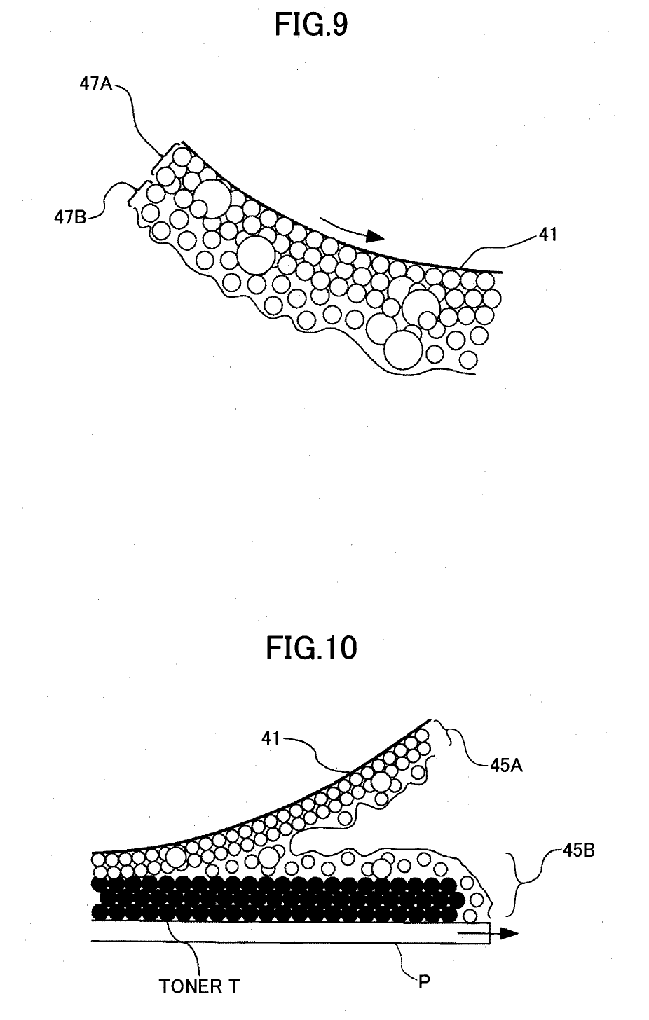

In this example, as shown in FIG. 9, the supplied amount (per unit time) of a foam fixing agent 47A having a low density generated by the second foam fixing agent generating unit 30-2, is larger than that of a foam fixing agent 47B used for fixing generated by the first foam fixing agent generating unit 30-1.

Accordingly, as shown in FIG. 9, the thickness of the foam fixing agent film 47A having a low density is higher than that of the foam fixing agent film 47B used for fixing.

As described above, the supplied amount (per unit time) of the foam fixing agent 47A having a low density generated by the second foam fixing agent generating unit 30-2, is larger than that of the foam fixing agent 47B used for fixing generated by the first foam fixing agent generating unit 30-1. Therefore, it is possible to increase the ratio of the foam fixing agent having a low density, in the foam fixing agent remaining on the foam application roller 41. Accordingly, it is possible to reduce the amount of foam fixing agent remaining on the foam application roller 41, thereby increasing the transfer rate even more.

An embodiment of the present invention may have the opposite configuration as that described above.

That is to say, the supplied amount (per unit time) of the foam fixing agent 47B used for fixing generated by the first foam fixing agent generating unit 30-1, may be larger than that of the foam fixing agent 47A having a low density generated by the second foam fixing agent generating unit 30-2.

Accordingly, even when color printing is performed, and plural toner colors are deposited to form an image (i.e., the height of deposited toner is high), there is enough foam fixing agent used for fixing to permeate the entire toner layer.

Next, FIG. 10 illustrates an example of a process of transferring the foam fixing agent in the fixing system using a two-layer foam fixing agent film. In this example, the two-layer foam fixing agent film shown in FIG. 7 is taken as an example.

Similar to FIG. 3, as the foam application roller 41 contacts the recording medium P while the recording medium P is being conveyed, the two layers of the foam fixing agent films 45A and 45B transfer to and permeate the unfixed toner T on the recording medium P.

As shown in FIG. 10, the foam fixing agent film 45B used for fixing is primarily the foam fixing agent that transfers to and permeates the unfixed toner T on the recording medium P. Accordingly, a large amount of the foam fixing agent film 45A having a low density remains on the foam application roller 41. Thus, even if the volume ratio of the fixing agent on recording medium:the volume ratio of the fixing agent remaining on foam application roller is 7:3, the weight ratio of the fixing agent on recording medium increases.

For example, it is assumed that foam films are formed with a foam used for fixing having a density of 0.05 g/cm³ and a foam having a low density of 0.01 g/cm³, and 90% of the foam remaining on the foam application roller 41 is the foam having a low density. In this case, even when the volume ratio of the fixing agent on recording medium:the volume ratio of the fixing agent remaining on foam application roller is 7:3, the weight ratio of the fixing agent on recording medium:the fixing agent on foam application roller is 9:1.

As described above, in the present embodiment, a two-layer foam film is formed on the foam application roller 41 with two types of foam fixing agents (the foam fixing agent film 45A having a low density and the foam fixing agent film 45B used for fixing). The two-layer foam film is applied to the unfixed toner T (resin particles) on the recording medium P. Accordingly, the density of the foam fixing agent remaining on the foam application roller 41 after the fixing operation can be reduced, so that the amount of the foam fixing agent remaining on the foam application roller 41 can be reduced.

In the above description, the two-layer foam film shown in FIG. 7 is taken as an example; however, the same description is also applicable to the two-layer foam films shown in FIG. 8 or 9.

In the above descriptions, the foam application roller 41 is taken as an example of the foam application member; however, the foam application member may be a foam application belt that is stretched around plural rollers. Furthermore, a pressurizing member facing the foam application member is not limited to the pressure roller 44; the pressurizing member may be a pressurizing belt that is stretched around plural rollers.

According to an embodiment of the present invention, a two-layer foam film is formed with two types of foam fixing agents (for example, a foam fixing agent having a low density and a foam fixing agent used for fixing), and the two-layer foam film is applied to resin particles on a medium. Accordingly, the density of the foam fixing agent remaining on the foam application member after the fixing operation can be reduced, so that the amount of the foam fixing agent remaining on the foam application member can be reduced.

The present invention is not limited to the specific embodiments described herein, and variations and modifications may be made without departing from the scope of the present invention.

The present application is based on Japanese Priority Applications No. 2010-054060 filed on Mar. 11, 2010 and No. 2010-236175 filed on Oct. 21, 2010 with the Japan Patent Office, the entire contents of which are hereby incorporated by reference.

1. A fixing device for applying a foam fixing agent to particles including resin resting on a medium to fix the particles including resin onto the medium, the foam fixing agent including a softener for softening the particles including resin by dissolving or swelling at least part of the resin, the foam fixing agent including a first foam fixing agent and a second foam fixing agent, the fixing device comprising:
a first foam fixing agent generating unit that generates the first foam fixing agent from a fixing agent;
a second foam fixing agent generating unit that generates the second foam fixing agent from the fixing agent, the second foam fixing agent having a lower density than the first foam fixing agent; and
a foam application member on which a first film formed with the first foam fixing agent and a second film formed with the second foam fixing agent are formed.

2. The fixing device according to claim 1, wherein
the first foam fixing agent includes the softener, and
the second foam fixing agent does not include the softener.

3. The fixing device according to claim 1, wherein
a supplied amount per unit time of the second foam fixing agent is larger than that of the first foam fixing agent.

4. The fixing device according to claim 1, wherein
the foam application member is a foam application roller, and
a two-layer foam fixing agent film is formed on the foam application roller and is applied to the particles including resin resting on the medium, the two-layer foam fixing agent film including the first film and the second film.

5. A fixing method for applying a foam fixing agent to particles including resin resting on a medium to fix the particles including resin onto the medium, the foam fixing agent including a softener for softening the particles including resin by dissolving or swelling at least part of the resin, the foam fixing agent including a first foam fixing agent and a second foam fixing agent, the fixing method comprising:
generating the first foam fixing agent from a fixing agent;
generating the second foam fixing agent from the fixing agent, the second foam fixing agent having a lower density than the first foam fixing agent; and
applying the first foam fixing agent and the second foam fixing agent to the particles including resin resting on the medium, with the use of a foam application member on which a first film formed with the first foam fixing agent and a second film formed with the second foam fixing agent are formed.

6. The fixing method according to claim 5, wherein
the generating the first foam fixing agent includes generating the first foam fixing agent including the softener, and
the generating the second foam fixing agent includes generating the second foam fixing agent that does not include the softener.

7. The fixing method according to claim 5, wherein
the generating the second foam fixing agent includes generating the second foam fixing agent whose supplied amount per unit time is larger than that of the first foam fixing agent.

8. The fixing method according to claim 5, wherein
the applying includes applying a two-layer foam fixing agent film to the particles including resin resting on the medium, with the use of a foam application roller used as the foam application member on which the two-layer foam fixing agent film is formed, the two-layer foam fixing agent film including the first film and the second film.

9. An image forming apparatus comprising:
an image forming unit that forms an unfixed image on a medium with the use of a developer including particles including resin, the particles including resin further including a color material; and
a fixing unit that fixes the unfixed image formed by the image forming unit onto the medium, wherein
the fixing unit is the fixing device according to claim 1.

10. An image forming method comprising:
forming an unfixed image on a medium with the use of a developer including particles including resin, the particles including resin further including a color material; and
fixing, onto the medium, the unfixed image formed at the forming, wherein
the fixing is performed by executing the fixing method according to claim 5.
